(19) United States
(12) Patent Application Publication
(10) Pub. No.: US 2008/0172801 A1
(43) Pub. Date: Jul. 24, 2008

(54) Gardening tool

(76) Inventor: Augusto G. Biag, Glen Ellyn, IL (US)

Correspondence Address: THE LAW OFFICE OF RANDALL T. ERICKSON, P.C., 1749 S. NAPERVILLE ROAD, SUITE 202, WHEATON, IL, 60187, US

(21) Appl. No.: 11/588,997

(22) Filed: Oct. 27, 2006

(51) Int. Cl. A01D 7/00

(52) U.S. Cl. 7/114

(57) ABSTRACT

A gardening tool includes a handle, a shaft and a pair of helical drill elements. The shaft extends from the handle longitudinally to a pointed shaft distal end. The pair of helical drill elements are spaced from and surround the shaft. The helical drill elements extend along the shaft and have free drill distal ends. The shaft distal end extends farther from the handle than does the drill distal ends. A debris-ejecting assembly includes a pusher slidable longitudinally along the shaft between the shaft and the drill elements. The ejecting assembly includes a spring arranged between a portion of the shaft and the pusher. The spring urges the pusher away from the shaft distal end toward the handle.

### TECHNICAL FIELD OF THE INVENTION

The present invention relates to a hand operated gardening tool. Particularly, the invention is directed to a hand-operated gardening tool adapted for pulling weeds.

### BACKGROUND OF THE INVENTION

Gardening, including vegetable and flower gardening and lawn maintenance, is a popular recreational activity in the United States. Gardening is a popular activity among retired persons and elderly persons. One drawback to gardening as an activity is the necessity to frequently pull weeds. Pulling weeds can be a strenuous activity particularly for elderly persons.

Attempts have been made to provide a tool to reduce the burden of pulling weeds. U.S. Pat. Nos. 4,832,132; 2,689,762; 1,924,002; 1,644,426; 4,456,075 and 4,819,736 disclose hand-operated weed pulling tools.

The present inventor has recognized that it would be desirable to provide a hand-operated gardening tool that was effective to pull weeds, ensuring that the weeds are entirely pulled including the roots, that also tilled the soil around the weed for better soil conditions for growing plants and flowers, and that allowed for the easy removal of the pulled weed from the tool without undue manipulation of the tool by the gardener.

The present inventor has recognized that it would be desirable to provide a hand-operated gardening tool that performed multiple functions including weed pulling, soil tilling and trash picking.

### SUMMARY OF THE INVENTION

The present invention provides a hand-operated gardening tool that is multi-functional. It one mode of operation, the gardening tool comprises a weed pulling device. In another mode of operation, the gardening tool functions as a soil tilling or aeration device to loosen the soil for better growing conditions for plants and flowers. In a further mode of operation, the tool can be used for picking leaves, paper or other trash from the ground. The multi-use gardening tool is lightweight, rugged, cost effectively manufactured and effective in operation.

According to one aspect of the invention, a gardening tool includes a handle, a shaft and a pair of helical drill elements. The shaft extends from the handle longitudinally to a pointed shaft distal end. The pair of helical drill elements are spaced from and surround the shaft. The helical drill elements extend along the shaft and have free drill distal ends. The shaft distal end extends farther from the handle than does the drill distal ends.

The invention can further include a debris-ejecting assembly. The debris-ejecting assembly includes a pusher slidable longitudinally along the shaft between the shaft and the drill elements. The ejecting assembly can include a spring arranged between a portion of the shaft and the pusher, the spring urging the pusher away from the shaft distal end toward the handle.

According to the preferred embodiment the shaft has a polygonal cross-section, such as a square cross-section. By virtue of the polygonal cross-section, weeds are more tightly wrapped and gripped by the shaft as it is driven and rotates downward into the weed and root growth.

Preferably the drill elements are helically coiled rods that wrap around the shaft about 360° with each drill distal end sharpened in order to effectively drill into soil.

The handle can be connected to the shaft by a ratchet connection.

According to another aspect of the invention, a gardening tool includes a handle portion, a weed removal shaft and a debris-ejecting assembly. The weed removal shaft extends from the handle portion longitudinally to a shaft distal end. The debris-ejecting assembly includes a pusher slidable longitudinally along the weed removal shaft from a retracted position distant from the shaft distal end to an extended position adjacent to the shaft distal end to push debris off of the weed removal shaft. A spring is arranged between a portion of the weed removal shaft and the pusher. The spring urges the pusher from the extended position toward the retracted position. A user operable handle part is connected to the pusher. When a weed is removed from the ground, or a piece of trash is speared by the shaft, it is retained on the shaft. The spring-loaded debris-ejecting assembly allows for easy removal of the debris from the shaft.

An advantage of the tool of the invention is that weed pulling and trash picking can all be accomplished without the user having a bend over or lift the tool to touch the shaft end with the user's hand to remove weeds or trash from the shaft. For older users, such an advantage is particularly important to allow for the enjoyable activity of gardening without arm and shoulder fatigue.

Numerous other advantages and features of the present invention will be become readily apparent from the following detailed description of the invention and the embodiments thereof, the claims and from the accompanying drawings.

### BRIEF DESCRIPTION OF THE DRAWINGS

FIG. 1 is a perspective view of a gardening tool of the invention;

FIG. 2 is a sectional view of the tool of FIG. 1;

FIG. 3 is a fragmentary bottom view taken generally along line 3-3 of FIG. 2;

FIG. 4 is a further fragmentary bottom view taken generally along line 3-3 of FIG. 2;

FIG. 5 is a perspective view of the tool shown in FIG. 1 in a first mode of operation;

FIG. 6 is a perspective view of the tool shown in FIG. 1 in a second mode of operation;

FIG. 7 is an enlarged, fragmentary elevational view of a bottom portion of the tool shown in FIG. 5 shown in the first mode of operation;

FIG. 8 is an enlarged, fragmentary elevational view of a bottom portion of the tool shown in FIG. 6 shown in the second mode of operation;

FIG. 9 is an enlarged, fragmentary view of an alternate embodiment handle portion for the tool shown in FIG. 1; and

FIG. 10 is an enlarged, fragmentary elevational view of a further alternate embodiment handle portion for the tool shown in FIG. 1.

### DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

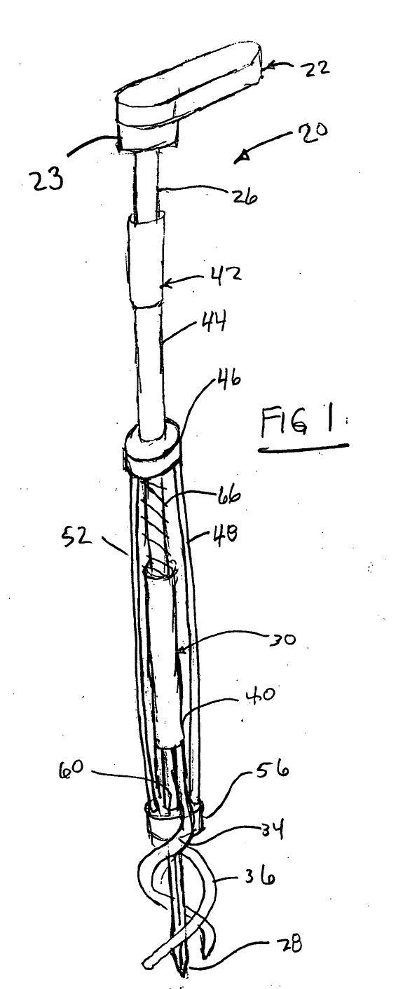

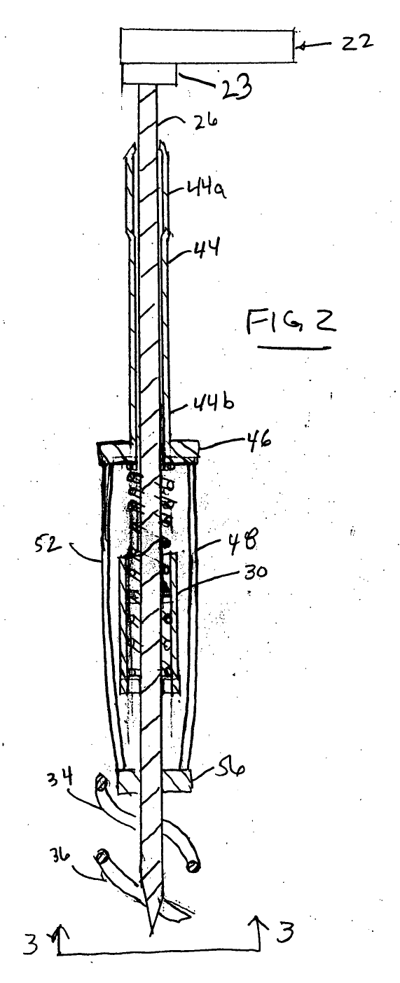

FIG. 1 illustrates a tool 20 according to the invention. The tool 20 includes a handle portion 22 that is connected to a shaft 26. The handle portion 22 can include a ratchet drive 23 that allows for a repeated limited rotational movement to achieve an aggregate rotational movement in a single rotational direction. The shaft 26 extends a length of the tool 20 to a pointed end 28. The shaft 26 has a square cross section. A drill assembly 30 is fixed to the shaft 26 and includes two helical drill elements 34, 36. The helical drill elements 34, 36 are connected at base ends 34a, 36a to the shaft 26 and to a spring tube 40.

The tool 20 can have an overall length of about 40 inches.

A debris-ejecting assembly 42 surrounds the shaft 26. The assembly 42 includes a handle part 44 that is connected to a base disk 46. Two spindles 48, 52 extend from the disk 46 to a pusher disk 56.

The pusher disk 56 has a diameter smaller than an inside clearance of the helical drill elements 34, 36. The pusher disk 56 includes a central aperture 60 that is sized to allow a sliding clearance between the pusher disk 56 and the shaft 26. The handle 44 and the base disk 46 include a central axial bore that has a sliding clearance between the shaft 26 and the assembly 42.

A coiled spring 66 surrounds the shaft 26 and is braced against an underside of the base disk 46 at a top end 66a of the spring 66 and inserts into the spring tube 40 at a lower portion of the spring 66.

As shown in FIG. 7, the helical drill elements 34, 36 are welded to the tube 40 and to the shaft 26. The welds are indicated in section at 67a, 67b, 67c, 67d.

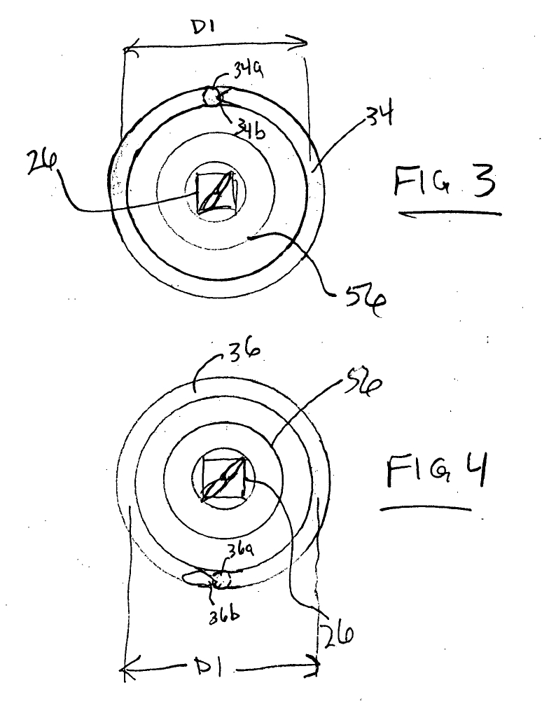

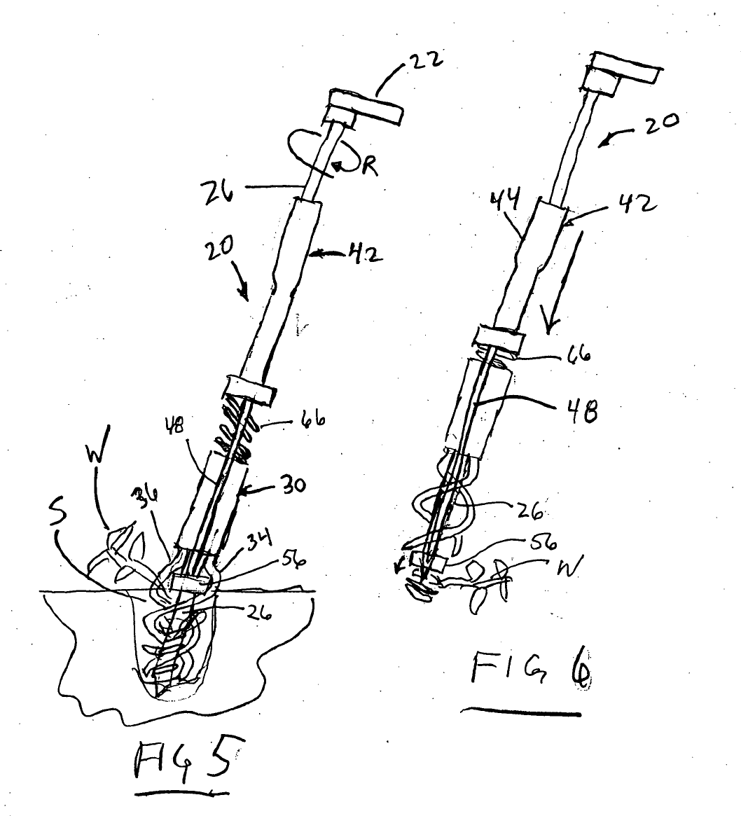

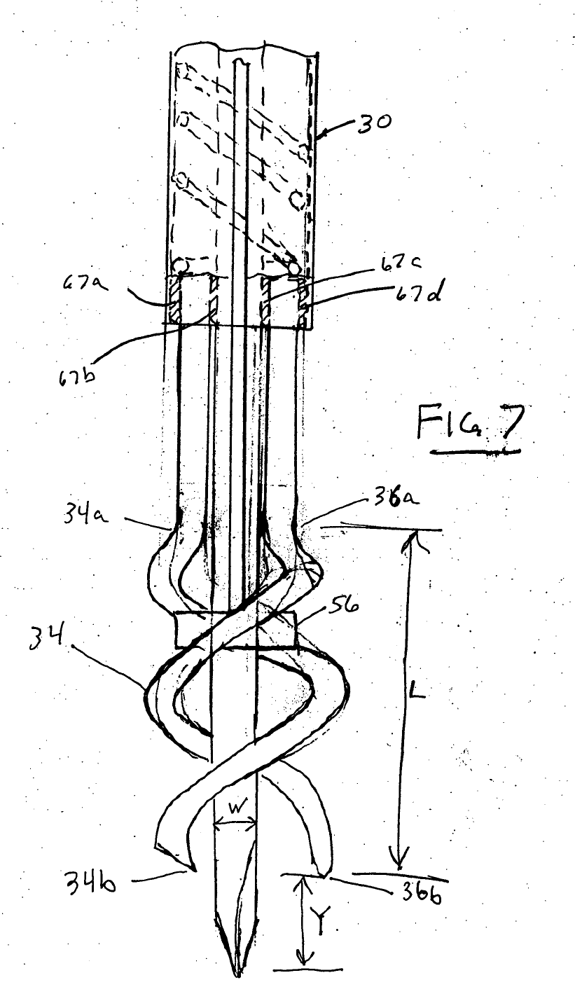

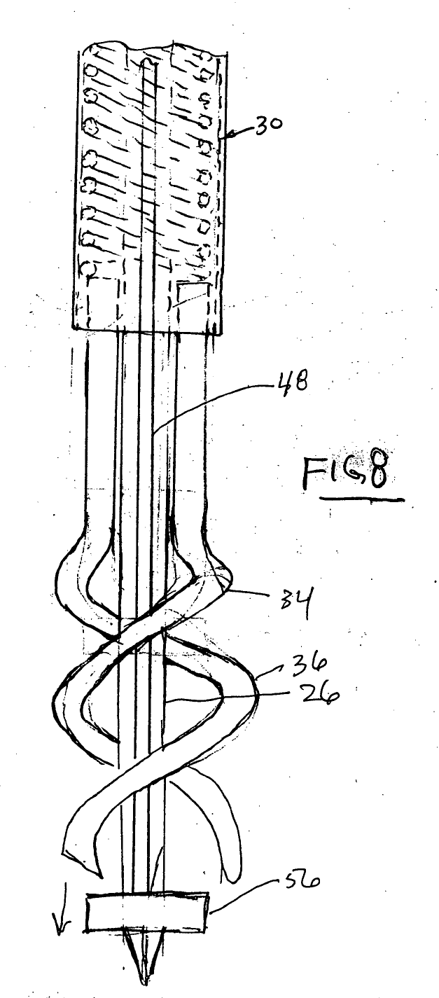

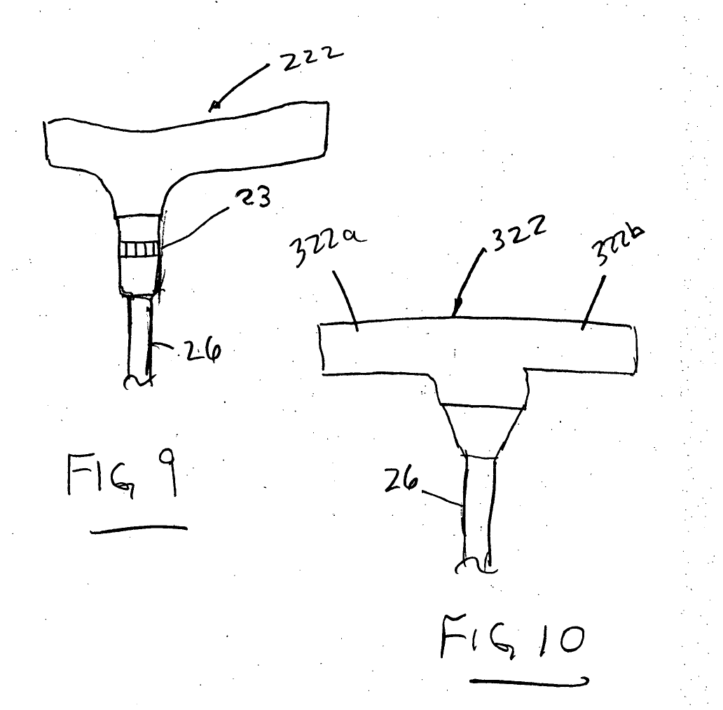

FIG. 3 illustrates the helical drill element 34 with the drill element 36 removed from the figure for clarity. The drill element 34 is preferably composed of a steel rod with a circular cross-section having a diameter of about 0.25 inches. The drill element 34 is rolled to have a mean diameter D1 preferably about 1.75 inches and extends around approximately 360° from a base end 34a to a distal end 34b. FIG. 4 illustrates the helical drill element 36 with the drill element 34 removed from the figure for clarity. As shown in FIG. 4, the helical drill element 36 is substantially identical to the drill element 34 and also has a mean diameter D1 and also extends around approximately 360° from base end 36a to distal end 36b. The helical drill elements 34, 36 preferably have an axial length L from base ends 34a, 36a to distal ends 34b, 36b of about 4 inches as shown in FIG. 7. The shaft 26 has a width W preferably about 5/16 inches and a length Y preferably about 1.5 inches that extends below the drill elements 34, 36.

In operation, as shown in FIGS. 5 and 7, the handle portion 22 is rotated clockwise to rotate the shaft 26 clockwise. The helical drill elements 34, 36 perform a digging, screwing action into the soil within a region S to break up and loosen the soil and drill the drill elements 34, 36 into the ground along with the shaft 26. As the shaft 26 rotates clockwise the weed W is wrapped around the shaft 26. Because the shaft 26 has a polygonal cross section, such as square, a tight wrapping and gripping of the weed, without slipping between the weed and the shaft 26, is achieved. The tool 20 can then be forcibly withdrawn upwardly to remove the weed through the loosened soil region S. Once the tool is lifted, by force from the users right (or left) hand, as shown in FIGS. 6 and 8, the handle part 44 of the ejector assembly 42 can be driven downward by force from the user's other hand. The spindles 48, 52 drive the pusher disk 56 down the shaft 26 to push or scrape the weed W off of the tool 20. Once the weed is ejected, the user ceases to exert downward force on the handle part 44 and the spring 66 returns the handle part 44 to its normal elevated position (FIG. 1).

To prevent over travel of the pusher disk 56 on the shaft 26, before the disk 56 passes over the pointed end 28 of the shaft 26, the base disk 46 contacts the top of the tube 40 which acts as a stop and prevents further axial travel of the pusher disk 56; or the spring 66 is compressed completely in the tube 30 to prevent further travel.

FIG. 9 shows an alternate embodiment handle portion 222 to the functional handle portion 22 shown in FIG. 1. According to this embodiment, the handle portion 222 can be styled as an elegant, wooden cane handle. A ratchet joint 23 can be incorporated into the handle 222 for one-way continuous rotation using a back and forth twisting of the handle.

FIG. 10 illustrates a further alternate embodiment handle portion 322 to the functional handle portion 22 shown in FIG. 1. According to this embodiment, the handle portion 322 extends laterally on opposite sides of the shaft 26 such that both ends 322a, 322b of the handle portion 322 can be gripped by the user's two hands to increase the torque which can be applied by the user to the weed pulling operation.

The ejector assembly 42 on the tool 20 allows the tool to also be effectively used as a trash picking device. The shaft 26 extends slightly below the helical drill elements 34, 36. The user can spear a piece of trash, such as a piece of paper, a cup or a bag and the ejector assembly 42 can be used to push or scrape the piece of trash off of the shaft 26.

An advantage of the ejector assembly 42 of the invention is that weed pulling and trash picking can all be accomplished without the user having a bend over or lift the tool to touch the shaft end 28 with the user's hand to remove weeds or trash from the shaft. For older users, such an advantage is particularly important to allow for the enjoyable activity of gardening without arm and shoulder fatigue.

Even in the absence of weeds, the tool 20 can also be used as a localized soil tilling device to loosen soil for the purpose of planting a plant or flower. In operation, the shaft 26 and the helical drill elements 34, 36 are driven and rotated into the soil to create the region S of loosened soil.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A gardening tool comprising:
a handle;
a shaft extending from said handle longitudinally to a pointed shaft distal end;
a pair of helical drill elements spaced from and surrounding said shaft, extending along said shaft and having free drill distal ends, wherein said shaft distal end extends farther from said handle than said drill distal ends.

2. The tool according to claim 1, further comprising:
a debris-ejecting assembly having a pusher slidable longitudinally along said shaft between said shaft and said drill elements.

3. The tool according to claim 2, further comprising a spring arranged between a portion of said shaft and said pusher, said spring urging said pusher away from said shaft distal end toward said handle.

4. The tool according to claim 1, wherein said shaft has a polygonal cross-section.

5. The tool according to claim 1, wherein said drill elements are helically coiled rods that wrap around said shaft about 360° and each drill distal end is sharpened in order to drill into soil.

6. The tool according to claim 1, wherein said handle is connected to said shaft by a ratchet connection.

7. A gardening tool comprising:
a handle;
a shaft extending from said handle longitudinally to a shaft distal end, wherein said shaft has a polygonal cross-section;
a pair of drill elements spaced from and surrounding said shaft extending along said shaft and having free drill distal ends.

8. The tool according to claim 7, wherein said drill elements comprise helically curved rods.

9. The tool according to claim 7, wherein said shaft comprises a square cross section.

10. The tool according to claim 7 wherein said tool comprises a debris-ejecting assembly having a pusher slidable longitudinally along said shaft between said shaft and said drill elements.

11. A gardening tool comprising:
a handle portion;
a weed removal shaft extending from said handle portion longitudinally to a shaft distal end;
a debris-ejecting assembly having a pusher slidable longitudinally along said weed removal shaft from a retracted position distant from said shaft distal end to an extended position adjacent to said shaft distal end to push debris off of said weed removal shaft, a spring arranged between a portion of said weed removal shaft and said pusher, said spring urging said pusher from said extended position toward said retracted position, and a user operable handle part connected to said pusher.

12. The tool according to claim 11, further comprising a pair of drill elements spaced from and surrounding said shaft extending along said shaft and having free drill distal ends.

13. The tool according to claim 12, wherein said drill elements are helically coiled rods that wrap around said shaft about 360° and each drill distal end is sharpened in order to drill into soil.
